(19) United States
(12) Patent Application Publication
(10) Pub. No.: US 2017/0024729 A1
(43) Pub. Date: Jan. 26, 2017

(54) Secure Transmission of Payment Credentials

(71) Applicant: Visa International Service Association, San Francisco, CA (US)

(72) Inventor: Horatio Nelson Huxham, Cape Town (ZA)

(21) Appl. No.: 15/302,160

(22) PCT Filed: Oct. 22, 2015
(86) PCT No.: PCT/IB2015/052046

§ 371 Date: Oct. 5, 2016

(30) Foreign Application Priority Data
Apr. 16, 2014 (ZA) 2014/02783

(51) Int. Cl. G06Q 20/38; G06Q 20/10; G06Q 20/40; H04L 9/08

(52) U.S. Cl. CPC G06Q 20/3829; H04L 9/0838; G06Q 20/102; G06Q 20/4018; H04L 2209/56

(57) ABSTRACT

A system and method for securely transmitting payment credentials to a payment processor is disclosed. A communications device of a consumer generates a first communicated value having a similar format to a second payment credential portion, and the first communicated value is provided to the payment processor to replace the second payment credential portion in the transmittal of the payment credentials. The communications device receives, from the payment processor, a second communicated value, and generates a payment credential encryption key based at least on the second communicated value. The payment processor generates the encryption key based at least on the first communicated value. The second payment credential portion is encrypted using the encryption key and is transmitted to the payment processor. The second payment credential portion together with a first payment credential portion provided to the payment processor constitute complete payment credentials required to process a financial transaction.

### CROSS-REFERENCE TO RELATED APPLICATION

This application claims priority to South African provisional patent application number 2014/02783, entitled “Secure Transmission of a Supplementary Payment Credential”, filed on 16 Apr. 2014, which is incorporated by reference herein.

### FIELD OF THE INVENTION

This invention relates to the secure transmission of payment credentials from a communications device of a consumer to a payment processor, wherein the payment credentials are usable to process a financial transaction.

### BACKGROUND TO THE INVENTION

Consumers are often required to provide payment credentials to a merchant in order to conduct a financial transaction in favor of the merchant. For example, during a card-not-present type transaction, the consumer is typically required to provide a primary account number (PAN), a card expiry date and a Card Verification Value (CVV or “CVV2”) associated with a financial account to the merchant.

If payment credentials are intercepted during a transaction or otherwise obtained by a miscreant, they may be used for fraudulent purposes. For example, a consumer may unwittingly provide complete payment credentials required to conduct a financial transaction to a miscreant posing as an online merchant. The miscreant may then use the payment credentials to conduct one or more transactions against the financial account of the consumer and in favor of a desired account.

In another example, it may be the case that a consumer possesses a feature phone which does not provide the same level of communication security and/or encryption capabilities as provided by certain smartphones. When the consumer uses the feature phone to transmit sensitive information such as payment credentials to a merchant and/or payment processor, there may be a significant risk of a miscreant intercepting or otherwise obtaining the information.

The present invention aims to address these and other problems, at least to some extent.

The preceding discussion of the background to the invention is intended only to facilitate an understanding of the present invention. It should be appreciated that the discussion is not an acknowledgment or admission that any of the material referred to was part of the common general knowledge in the art as at the priority date of the application.

### SUMMARY OF THE INVENTION

In accordance with the invention there is provided a method of securely transmitting payment credentials to a payment processor, the method carried out at a communications device of a consumer and comprising:
generating a first communicated value, the first communicated value having a similar format to a second payment credential portion;
providing the first communicated value to the payment processor, the first communicated value acting as a replacement for the second payment credential portion in the transmittal of the payment credentials;
receiving, from the payment processor, a second communicated value;
generating a payment credential encryption key based at least on the second communicated value, wherein the payment processor generates the payment credential encryption key based at least on the first communicated value;
encrypting the second payment credential portion using the payment credential encryption key, the second payment credential portion together with a first payment credential portion provided to the payment processor constituting complete payment credentials required to process a financial transaction; and
transmitting the encrypted second payment credential portion to the payment processor such that the payment processor is capable of decrypting the encrypted second payment credential portion using the payment credential encryption key in order to be in possession of the complete payment credentials required to process the financial transaction.

Further features provide for the step of generating the first communicated value to include generating the first communicated value based on a communications device private value and at least one shared value being known to the payment processor and to the communications device, wherein the second communicated value is generated based on a payment processor private value and the at least one shared value, wherein the step of generating the payment credential encryption key includes generating the payment credential encryption key based on the second communicated value and the communications device private value, and wherein the payment processor generates the payment credential encryption key based on the first communicated value and the payment processor private value.

In some embodiments, the step of providing the first communicated value to the payment processor may include providing the first communicated value to a merchant for onward transmission to the payment processor.

Yet further features provide for the first communicated value to be provided to the merchant together with the first payment credential portion; and for the first communicated value to be provided to the merchant instead of providing the merchant with the second payment credential portion such that the merchant is not in possession of the complete payment credentials required to process a financial transaction.

In some embodiments, the method may include the step of encrypting the first payment credential portion using the payment credential encryption key and transmitting the encrypted first payment credential portion to the payment processor.

Still further features provide for the at least one shared value to include a prime number and a base number used with the communications device private value to generate the first communicated value, and used with the payment processor private value to generate the second communicated value; and for the payment credential encryption key to be calculated using Diffie-Hellman key exchange protocol or a key exchange protocol substantially derived therefrom.

Further features provide for the step of providing the first communicated value to the merchant to include displaying the first communicated value such that the consumer is capable of providing it to the merchant; for the step of providing the first communicated value to the merchant to further include displaying an instruction to the consumer to provide the first communicated value to the merchant together with the first payment credential portion; and for the step of providing the first communicated value to the merchant to include transmitting the first communicated value to an acceptance point of the merchant.

In some embodiments, the similar format of the first communicated value enables the first communicated value to be accepted by a merchant as a second payment credential portion. The first communicated value may be in a format substantially similar to a format of a card verification value (CVV) associated with a financial account of the consumer.

Yet further features provide for the first payment credential portion to include a primary account number (PAN) and/or a card expiry date associated with a financial account of the consumer and to be devoid of a CVV; and for the second payment credential portion to be the CVV corresponding to the PAN and/or card expiry date.

Still further features provide for the communications device private value and/or the payment processor private value and/or the at least one shared value to be periodically updated; and for the communications device private value and/or the payment processor private value and/or the at least one shared value to be updated each time a respective first communicated value and/or second communicated value is generated.

The first communicated value may be valid for a single use only. The communications device may be a mobile phone. In some embodiments, the communications device may be a feature phone.

The invention extends to a method of securely transmitting payment credentials to a payment processor, the method carried out at the payment processor and comprising:
receiving a first communicated value, the first communicated value having a similar format to a second payment credential portion;
receiving a first payment credential portion;
generating a second communicated value;
transmitting the second communicated value to a communications device of a consumer;
generating a payment credential encryption key based at least on the first communicated value, wherein the communications device generates the payment credential encryption key based at least on the second communicated value;
receiving the second payment credential portion in an encrypted format, the second payment credential portion being encrypted using the payment credential encryption key, the second payment credential portion together with the first payment credential portion constituting complete payment credentials required to process a financial transaction;
decrypting the encrypted second payment credential portion using the payment credential encryption key; and
processing the financial transaction using the first payment credential portion together with the second payment credential portion.

Further features provide for the step of generating the second communicated value to include generating the second communicated value based on a payment processor private value and at least one shared value being known to the payment processor and to the communications device, wherein the first communicated value is generated based on a communications device private value and the at least one shared value, wherein the step of generating the payment credential encryption key includes generating the payment credential encryption key based on the first communicated value and the payment processor private value, and wherein the communications device generates the payment credential encryption key based on the second communicated value and the communications device private value.

The invention further extends to a system for securely transmitting payment credentials to a payment processor, the system comprising a communications device of a consumer in communication with a payment processor, the communications device including:
a first generating component for generating a first communicated value, the first communicated value having a similar format to a second payment credential portion;
a provisioning component for providing the first communicated value to the payment processor, the first communicated value acting as a replacement for the second payment credential portion in the transmittal of the payment credentials;
a receiving component for receiving, from the payment processor, a second communicated value;
a second generating component for generating a payment credential encryption key based at least on the second communicated value, wherein the payment processor generates the payment credential encryption key based at least on the first communicated value;
a cryptographic component for encrypting the second payment credential portion using the payment credential encryption key, the second payment credential portion together with a first payment credential portion provided to the payment processor constituting complete payment credentials required to process a financial transaction; and
a transmitting component for transmitting the encrypted second payment credential portion to the payment processor such that the payment processor is capable of decrypting the encrypted second payment credential portion using the payment credential encryption key in order to be in possession of the complete payment credentials required to process the financial transaction.

The invention yet further extends to a system for securely transmitting payment credentials to a payment processor, the system comprising a payment processor in communication with a communications device of a consumer, the payment processor including:
a value receiving component for receiving a first communicated value, the first communicated value having a similar format to a second payment credential portion;
a first payment credential component for receiving a first payment credential portion;
a first generating component for generating a second communicated value;
a transmitting component for transmitting the second communicated value to the communications device;
a second generating component for generating a payment credential encryption key based at least on the first communicated value, wherein the communications device generates the payment credential encryption key based at least on the second communicated value;
a second payment credential component for receiving the second payment credential portion in an encrypted format, the second payment credential portion being encrypted using the payment credential encryption key, the second payment credential portion together with the first payment credential portion constituting complete payment credentials required to process a financial transaction;
a cryptographic component for decrypting the encrypted second payment credential portion using the payment credential encryption key; and
a transaction processing component for processing the financial transaction using the first payment credential portion together with the second payment credential portion.

The invention still further extends to a computer program product for securely transmitting payment credentials to a payment processor, the computer program product comprising a computer-readable medium having stored computer-readable program code for performing the steps of:
generating a first communicated value, the first communicated value having a similar format to a second payment credential portion;
providing the first communicated value to the payment processor, the first communicated value acting as a replacement for the second payment credential portion in the transmittal of the payment credentials;
receiving, from the payment processor, a second communicated value;
   generating a payment credential encryption key based at least on the second communicated value, wherein the payment processor generates the payment credential encryption key based at least on the first communicated value;
encrypting the second payment credential portion using the payment credential encryption key, the second payment credential portion together with a first payment credential portion provided to the payment processor constituting complete payment credentials required to process a financial transaction; and
transmitting the encrypted second payment credential portion to the payment processor such that the payment processor is capable of decrypting the encrypted second payment credential portion using the payment credential encryption key in order to be in possession of the complete payment credentials required to process the financial transaction.

The invention even further extends to a computer program product for securely transmitting payment credentials to a payment processor, the computer program product comprising a computer-readable medium having stored computer-readable program code for performing the steps of:
receiving a first communicated value, the first communicated value having a similar format to a second payment credential portion;
receiving a first payment credential portion;
generating a second communicated value;
transmitting the second communicated value to a communications device of a consumer;
generating a payment credential encryption key based at least on the first communicated value, wherein the communications device generates the payment credential encryption key based at least on the second communicated value;
receiving the second payment credential portion in an encrypted format, the second payment credential portion being encrypted using the payment credential encryption key, the second payment credential portion together with the first payment credential portion constituting complete payment credentials required to process a financial transaction;
decrypting the encrypted second payment credential portion using the payment credential encryption key; and
processing the financial transaction using the first payment credential portion together with the second payment credential portion.

The computer-readable medium may be a non-transitory computer-readable medium, the computer-readable program code being executable by a processing circuit.

In order for the invention to be more fully understood, implementations thereof will now be described with reference to the accompanying drawings.

### BRIEF DESCRIPTION OF THE DRAWINGS

The invention will now be described, by way of example only, with reference to the accompanying representations in which:

FIG. 1A is a schematic illustration of an embodiment of a system for securely transmitting payment credentials;

FIG. 1B is a block diagram illustrating components of an embodiment of a communications device;

FIG. 10 is a block diagram illustrating components of an embodiment of a payment processor;

FIG. 2 is a swim-lane flow diagram illustrating an exemplary method of securely transmitting payment credentials;

FIG. 3 is a table illustrating steps conducted in transmitting payment credentials according embodiments described herein;

FIG. 4 illustrates a number of stages in an exemplary implementation of a system and method for securely transmitting payment credentials;

FIG. 5 shows a block diagram of a computing device in which various aspects of the disclosure may be implemented; and,

FIG. 6 shows a block diagram of a mobile device that may be used in embodiments of the disclosure.

### DETAILED DESCRIPTION WITH REFERENCE TO THE DRAWINGS

Embodiments described herein provide a system and method for securely transmitting payment credentials to a payment processor. A communications device of a consumer generates a first communicated value having a similar format to a second payment credential portion, and the first communicated value is provided to the payment processor, in some embodiments acting to replace the second payment credential portion in the transmittal of the payment credentials. The communications device receives, from the payment processor, a second communicated value, and generates a payment credential encryption key based at least on the second communicated value. The payment processor may generate the encryption key based at least on the first communicated value. The second payment credential portion may be encrypted using the encryption key and is transmitted to the payment processor. The second payment credential portion together with a first payment credential portion provided to the payment processor constitute complete payment credentials required to process a financial transaction.

Throughout the specification, the term “complete payment credentials” should be broadly interpreted and may include any payment or financial account details that can be used to process a transaction. The first payment credential portion may be any part of the complete payment credentials while the second payment credential portion is the remaining part such that the first and second portions together form the complete payment credentials. In some embodiments, the first payment credential portion is transmitted “in the clear” during a transaction, while a shared key is used to transmit the second payment credential portion in an encrypted format.

The techniques described may provide numerous advantages over known techniques for transmitting payment credentials. Firstly, the risk of complete payment credentials required to conduct a transaction being intercepted by a miscreant may be reduced. Secondly, the risk of a consumer unwittingly providing complete payment credentials to a miscreant posing as a merchant may also be reduced. Thirdly, the technique may enhance the security of payment credential transmission for consumers using feature phones, which may at least in some cases not provide the same level of transaction and/or communication security as provided by certain smartphones. These and other advantages will become more apparent from the exemplary embodiments described below.

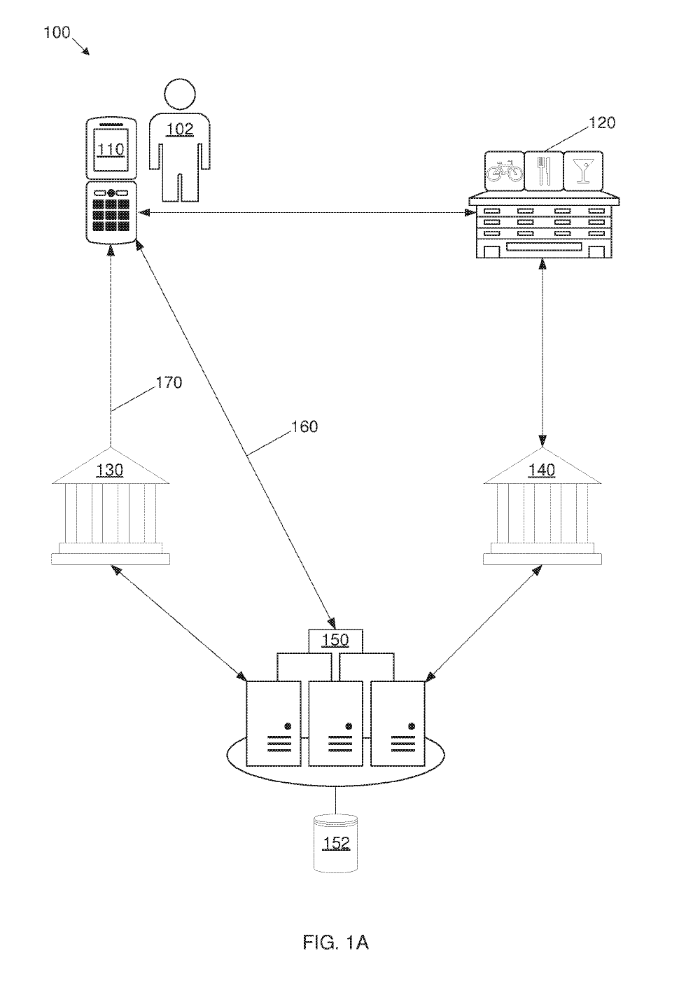

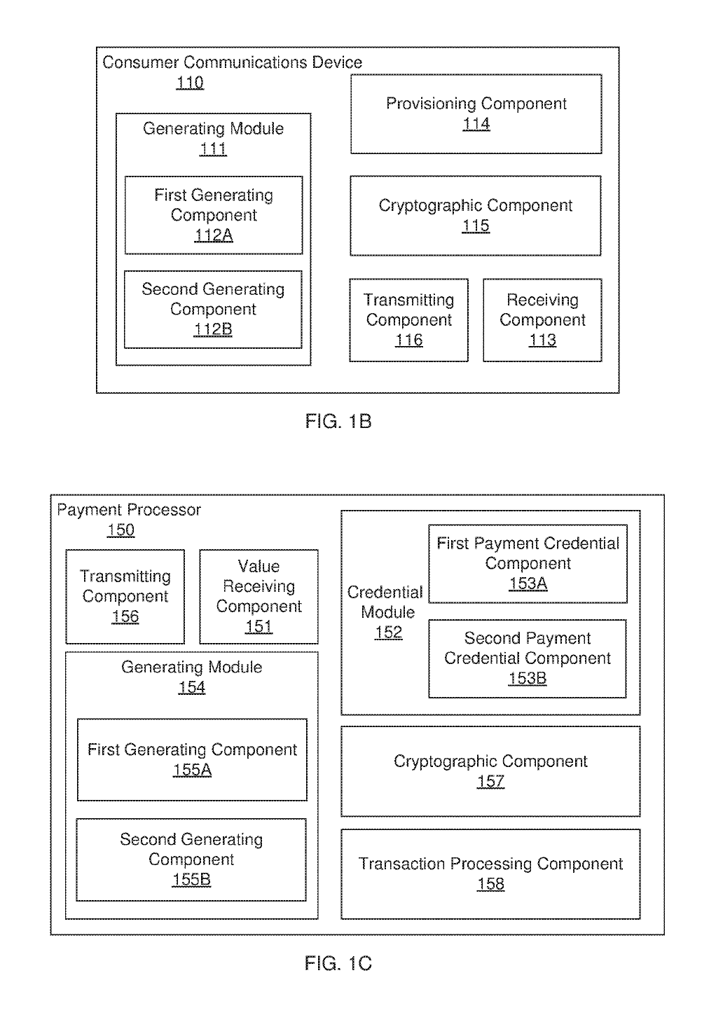

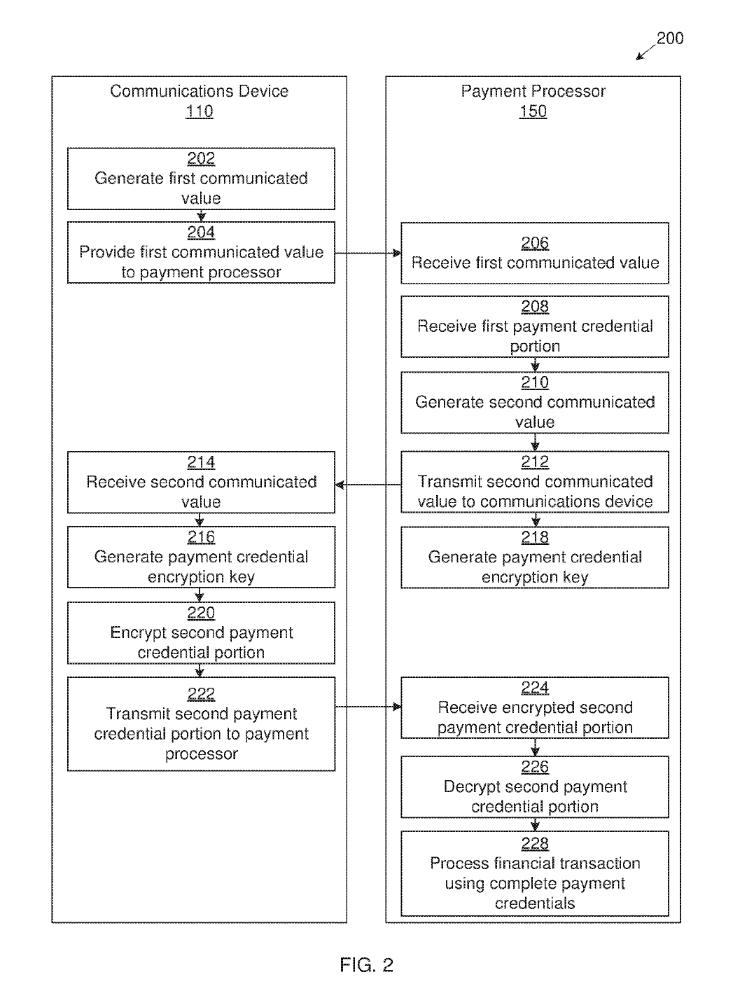

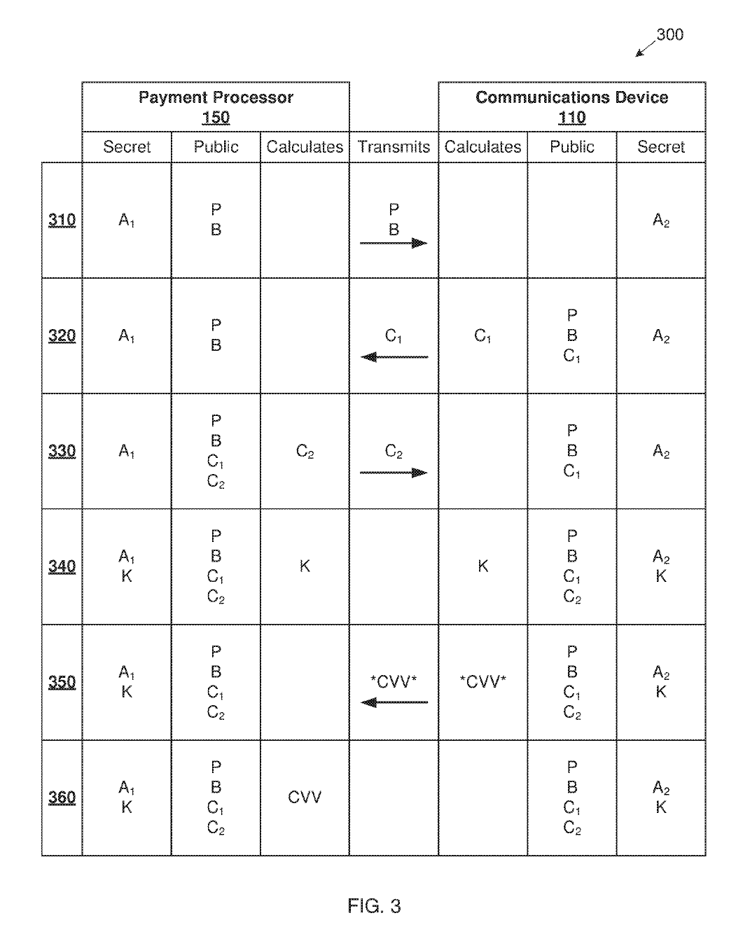

FIG. 1A illustrates an embodiment of a system (100) for securely transmitting payment credentials. The system (100) may include a consumer (102) having a consumer communications device (110), a merchant (120), an issuing entity (130), an acquiring entity (140) and a payment processor (150). The system (100) may, of course, include a plurality of consumers each operating a consumer communications device, and it should thus be noted FIG. 1A shows a single consumer primarily for exemplary purposes.

In this embodiment, the consumer communications device (110) is a mobile phone, the issuing entity (130) is an issuing bank at which the consumer holds a financial account, the acquiring entity (140) is an acquiring bank of the merchant (120), and the payment processor (150) forms part of a payment processing network.

The payment processor (150) may be part of a payment processing network such as VisaNet™. The payment processor (150) has one or more database (152) which contains details of multiple accounts, including the account of the consumer (102), and is configured to process transactions conducted against the accounts. Typically, the payment processor (150) may be provided with payment credentials via the merchant (120) in order to process a financial transaction, as will be well understood by those of ordinary skill in the art.

The payment processing network may include data processing subsystems, networks, and operations used to support and deliver authorization services, exception file services, and clearing and settlement services. Payment processing networks such as VisaNet™ are able to process credit card transactions, debit card transactions, and other types of commercial transactions. Furthermore, the payment processing network may include one or more servers and may use any suitable wired or wireless network, including the Internet.

Although the communications device (110) is a mobile phone in this embodiment, the term “communications device” should throughout this specification be interpreted so as to include any electronic communications device capable of communicating over a communications network, such as a cellular network, and having at least a limited amount of processing power.

The term should be interpreted to include all mobile or cellular phones but may also include portable or non-portable computers such as laptops, personal computers and the like. The term should specifically be interpreted to include feature mobile phones which may lack the capability to use sophisticated or advanced techniques for encrypting and/or securely transmitting and receiving data.

The communications device (110) possessed by the consumer (102) may be capable of communicating directly with the payment processor (150) over any suitable communications channel. In this embodiment, a payment application is installed on the communications device (110) and is configured to transmit data to and receive data from the payment processor (150) over a mobile communications channel (160). Any suitable communications channel may be used for communication between the consumer (102) and the merchant (120), the merchant (120) and the acquiring entity (140), and between the payment processor (150) and the issuing and acquiring entities (130, 140) respectively, as will be well understood by those of ordinary skill. In some embodiments, the issuing entity (130) may communicate with the communications device (110), for example, for transaction authorization or notification purposes. This is indicated by the broken line (170) in FIG. 1A.

Embodiments of the communications device (110) may include one or more of a generating module (111), a receiving component (113), a provisioning component (114), a cryptographic component (115) and a transmitting component (116). The generating module (111) may include a first generating component (112A) for generating a first communicated value and a second generating component (112B) for generating a payment credential encryption key. These components are illustrated in FIG. 1B, and their functionality will be described in greater detail with reference to FIGS. 2 to 4. In some embodiments, at least one of the components shown in FIG. 1B are provided by a software application installed on the communications device. The software application may be a payment application provided by or associated with the payment processor. For example, the payment application may provide the generating module (111) and the consumer (102) may operate the payment application to obtain the first communicated value which may be provided to the merchant (120).

Components of an embodiment of the payment processor (150) are shown in FIG. 1C. The payment processor (150) may include a value receiving component (151), a credential module (152), a generating module (154), a transmitting component (156), a cryptographic component (157) and a transaction processing component (158). The credential module (152) may include a first payment credential component (153A) and a second payment credential component (153B), and the generating module (154) may include a first generating component (155A) for generating a second communicated value and a second generating component (155B) for generating a payment credential encryption key. These components may be distributed among a number of servers or components of the payment processor (150), which may be physically separate, and may be provided by one or more applications resident thereon. The functioning of each of these components are also described with reference to FIGS. 2 to 4.

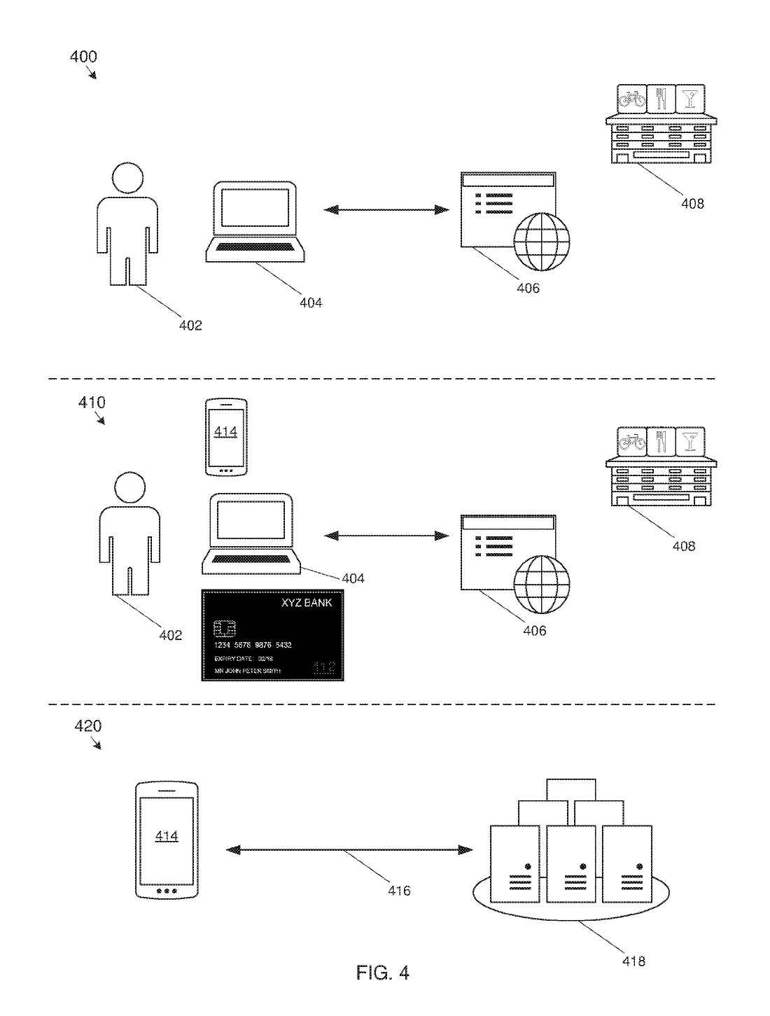

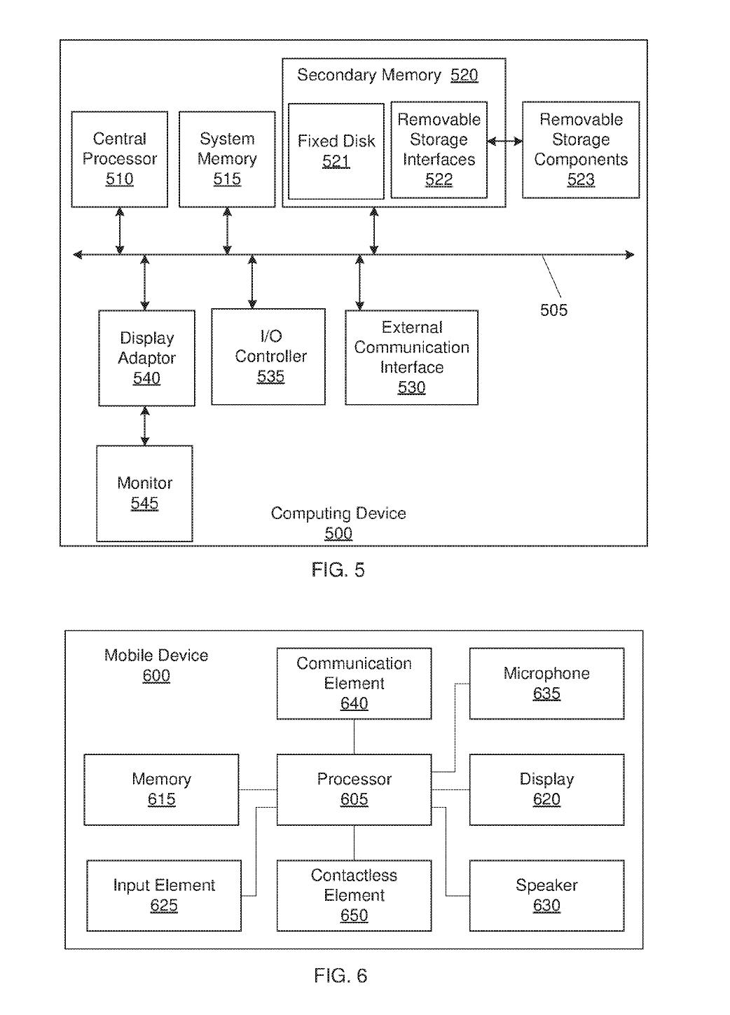

The system (100) and components described with reference to FIGS. 1A to 10 enables a second payment credential portion, which together with a first payment credential portion makes up the complete payment credentials needed to process a transaction, to be securely transmitted from the communications device (110) of the consumer (102) to the payment processor (150) such that the payment processor (150) is in possession of complete payment credentials required to process a financial transaction against the account of the consumer (120) and in favor of the merchant (120). Embodiments provide for the second payment credential portion to be transmitted such that it bypasses the merchant (120) to ensure that the merchant (120) does not come into possession of the complete payment credentials.

The flow diagram (200) of FIG. 2 illustrates steps conducted at both the communications device (110) of the consumer (102) and the payment processor (150) in an example of a technique which can be used to securely transmit such a second payment credential portion in order to process a financial transaction.

At a first stage (202), the communications device (110) may generate a first communicated value. The first communicated value may be generated at the first generating component (112A) of the communications device (110). In some embodiments, the first communicated value is generated based on a communications device private value and at least one shared value which is known to both the payment processor (150) and the communications device (120).

The at least one shared value may be coded into the payment application or transmitted to the communications device (110) from the payment processor (150). The communications device private value may be generated by the payment application or received from a third party entity such that it is not known to the payment processor (150).

At a next stage (204), the first communicated value may be provided to the payment processor (150). The first communicated value may be provided to the payment processor (150) using the provisioning component (114). Typically, and as illustrated in FIG. 1A, the first communicated value is provided to the payment processor (150) by providing it to the merchant (120) for onward transmission to the payment processor (150). The first communicated value is typically provided to the merchant (120) along with a first payment credential portion as described above, the first communicated value and first payment credential portion being provided to the merchant (120) for conducting a financial transaction in favor of the merchant (120).

The first communicated value and/or the first payment credential portion may, for example, be provided to the merchant by transmitting it to an acceptance point of the merchant (120), such as an online payment portal or secure website, a point of sale (POS) device, provided to the merchant (120) over a telephonic channel, or the like. The consumer (102) may, for example, use a computer (not shown) to access a website and enter the first communicated value generated at the communications device (102) and/or the first payment credential portion as input to a website associated with the merchant (120).

The first communicated value and the first payment credential portion may also be provided separately or along different channels, or it may be the case that the payment processor (150) already possesses the first payment credential portion and only the first communicated value needs to be provided to the payment processor (150), whether via the merchant (120) or in any other suitable manner.

The payment processor (150), at a next stage (206), may receive the first communicated value at its value receiving component (151). In some embodiments, the first communicated value may be received via the acquiring entity (140) associated with the merchant (120). The payment processor (150) may also receive (208) the first payment credential portion at its first payment credential component (153A). The first communicated value and first payment credential portion may be received simultaneously, at different times and/or from different sources. In some embodiments, the first communicated value and first payment credential portion may be included in a transaction request message sent to the payment processor (150).

Typically, the payment processor (150) may identify the consumer in question based on some identifier it has received. For example, if the first payment credential portion includes a PAN associated with a credit card of the consumer, the payment processor (150) may use the PAN to identify the consumer and the consumer's financial account it has stored details of.

At a next stage (210), the payment processor (150) may generate a second communicated value. The second communicated value may be generated based on a payment processor private value and the at least one shared value described above. The shared value may be stored in association with the consumer of the consumer account, and the payment processor (150) may, after identifying the consumer attempting to transact, look up the shared value to use. The payment processor private value is typically generated at the payment processor (150) and is unknown to the communications device (102). The second communicated value may be generated at the first generating component (155A) of the payment processor (150). At a next stage (212), the payment processor (150) transmits the second communicated value to the communications device (110) via its transmitting component (156).

The communications device (110) then, using its receiving component (113), may receive the second communicated value at a next stage (214). In some embodiments, once the communications device (110) has received the second communicated value and the payment processor (150) has received the first communicated value, both may be configured to generate a symmetric payment credential encryption key. The communications device (110) generates (216) the payment credential encryption key using its second generating component (112B), in some embodiments based on the second communicated value and the communications device private value, while the payment processor (150) generates (218) the payment credential encryption key at its second generating component (115B), in some embodiments based on the first communicated value and the payment processor private value.

The payment processor (150) requires a second payment credential portion in conjunction with the first payment credential portion it has received, which may have been at a prior stage or during the transaction in question, in order to be in possession of complete payment credentials of the consumer (102) for processing the transaction in favor of the merchant. The communications device (110) may use its cryptographic component (115) to encrypt the second payment credential portion using the payment credential encryption key at a next stage (220), and at a further stage (222) transmits the encrypted second payment credential portion to the payment processor (150) using its transmitting component (156), for example, over an encrypted data channel.

The payment processor (150) may be capable of receiving (224) the encrypted credential at its second payment credential component (153B), decrypting (226) the encrypted credential using its cryptographic component (157), and using the second payment credential portion together with the first payment credential portion to process the transaction at a final stage (228).

The transaction may be processed using the transaction processing component (158) or may be forwarded to a different entity for authorization and/or processing. Processing may typically involve transmitting the complete payment credentials obtained to the issuing entity (130) for validation thereof. After the issuing entity (130) has validated the credentials, the account of the consumer (102) may be debited in favor of the merchant, an account of which is then credited at the acquiring entity (140). The payment processor (150) may transmit and authorization response message indicating that the transaction was successfully processed to the acquiring entity (140), which may in turn notify the merchant (120).

In this way, the merchant or any other party intercepting or otherwise obtaining data communicated within the system (100) of FIG. 1A may be prevented from being in possession of the complete payment credentials required to conduct a transaction against the account of the consumer (102) at any stage.

In some embodiments, the first payment credential portion may be encrypted using the payment credential encryption key and transmitted to the payment processor (150), instead of, for example, transmitting the first payment credential portion via the merchant (120).

A further exemplary implementation of the method and system for securely transmitting payment credentials will now be described with reference to FIG. 3. The table (300) of FIG. 3 illustrates various values used in order to ultimately securely transmit a second payment credential portion to the payment processor (150), and identifies values which are secret, public, calculated and transmitted by both the payment processor (150) and the communications device (110) of the consumer (102) at various stages.

In this particular example, the payment credential encryption key is calculated using the Diffie-Hellman key exchange protocol, and the first communicated value is in a substantially similar format to a format of a card verification value (CVV) associated with the financial account of the consumer (102). The first payment credential portion consists of a primary account number (PAN) and a card expiry date associated with the financial account of the consumer and are devoid of the CVV. The second payment credential portion is the CVV corresponding to the PAN and the card expiry date, and the second payment credential portion and the first payment credential portion in conjunction form complete payment credentials required to process a transaction.

It should be appreciated that any suitable key exchange protocol which results in a shared secret may be employed without departing from the scope of the invention. For example, techniques such as Simple Password Exponential Key Exchange (SPEKE) or MQV (Menezes-Qu-Vanstone) may be used.

In this example and in embodiments described throughout the specification, the first communicated value acts as a replacement for the second payment credential portion. In this embodiment, the first communicated value is provided to the merchant (120) instead of the second payment credential portion, in other words instead of the actual CVV of the consumer, in order to ensure that complete payment credentials are not transmitted “in the clear”. In this way the merchant is not in possession of the complete payment credentials required to process a financial transaction. The similar format of the first communicated value may enable the first communicated value to be accepted by a merchant as a second payment credential portion (e.g. CVV).

In some embodiments, providing the actual CVV, or any other second payment credential portion as chosen, to the merchant instead of providing the first communicated value may also cause the transaction to fail. This may serve as a warning that the party attempting to transact is not aware that a first communicated value should be provided instead of the actual second payment credential portion. In this way, a potentially fraudulent transaction or request may be detected.

Throughout this specification, the term “CVV” should be broadly interpreted and is used to refer to any security feature used in addition to an account number or bank card number, typically in card-not-present transactions. The term therefore includes security features such as a card security code (CSC), card verification data (CVD), card code verification (CCV), signature panel code (SPC), a card verification code (CVC or CVC2), a CVV2, and the like.

The first communicated value may, for example, in further embodiments act as a replacement card expiry date and not as a replacement CVV. In such a case, the consumer (102) may provide the PAN and CVV to merchant along with a replacement card expiry date, whilst the second payment credential portion provided to the merchant is the actual expiry date required to form the complete payment credentials. It should further be understood that the second payment credential portion may be any suitable portion of the complete payment credentials, and not necessarily a complete CVV, a complete PAN, or the like. The second payment credential portion may, for example, simply be four PAN digits to replace four of the actual PAN digits, with the first payment credential portion including the remainder of the credentials required to form the full set of payment credentials.

In accordance with the principles of Diffie-Hellman key exchange protocol, the at least one shared value consists of two values in this case, namely a prime number and a base number, the base number being a primitive root modulo of the prime number. The prime number and base number are used with the communications device private value to generate the first communicated value, and also with the payment processor private value to generate the second communicated value.

Turning to the specific example shown in FIG. 3, at a first stage (310), the payment processor (150) is in possession of the payment processor private value (A₁) and the communications device (110) is in possession of the communications device private value (A₂). These values are secret and thus only known to the respective parties. In this example, the payment processor (150) transmits shared or “public” values in the form of the prime number (P) and the base number (B) to the communications device (110). The term “public” is used to refer to values which are known to the payment processor (150) and the communications device (110), and optionally to an entity or entities intercepting or otherwise obtaining values transmitted between the payment processor (150) and the communications device (110). This includes values that may be obtained by the merchant (120) during a transaction procedure.

At a next stage (320), the communications device (110) generates the first communicated value (C₁) using the following equation:

C₁=B^{A}^{₂} mod P (1)

As described above, the first communicated value (C₁) is provided to the merchant (120) as a CVV instead of providing the real CVV to the merchant. Providing the first communicated value (C₁) to the merchant (120) may, for example, involve displaying the replacement CVV such that the consumer is capable of providing it to the merchant (120) along with the first payment credential portion (e.g. PAN and expiry date). This may also include displaying an instruction to the consumer (110) to provide the replacement CVV to the merchant (120) together with the first payment credential portion.

The first communicated value (C₁) then reaches the payment processor (150), for example via a suitable acceptance point of the merchant (120), and is thus public.

At a next stage (330), the payment processor (150) generates the second communicated value (C₂) using the following equation:

C₂=B^{A}^{₁} mod P (2)

The second communicated value (C₂) is transmitted to the communications device (110) of the consumer (102), and is thus public. The first communicated value (C₁) and second communicated value (C₂) are then respectively used by the payment processor (150) and the communications device (110) to calculate a symmetric payment credential encryption key.

At a next stage (340), the payment processor (150) generates the payment credential encryption key (K) using the following equation:

K=C₁^{A}^{₁} mod P (3)

The communications device (110) in turn generates the payment credential encryption key (K) using the following equation:

K=C₂^{A}^{₂} mod P (4)

The payment credential encryption key (K) is not public, and is thus indicated as secret to both the payment processor (150) and the communications device (110) in FIG. 3.

At a next stage (350), the communications device (110) transmits the second payment credential portion, in other words the actual CVV corresponding to the first payment credential portion, to the payment processor (150). The actual CVV may be encrypted using the payment credential encryption key (K) in any suitable symmetric algorithm and as will be well understood by those skilled in the art, to yield an encrypted second payment credential portion (*CVV*). The actual CVV may, for example, be stored on the communications device (110) and the consumer (102) may be required to enter a password before it is encrypted and transmitted to the payment processor (150).

It should be appreciated that the second payment credential portion may be transmitted to the payment processor (150) in any format, including a format which is, for example, not a standard CVV format, as the second payment credential portion may not need to be accepted at an acceptance point of a merchant.

At a final stage (360), the payment processor (150) decrypts the encrypted second payment credential portion (*CVV*) using the payment credential encryption key (K) to yield the actual CVV. This ensures that the payment processor (150) is in possession of the complete payment credentials required to process the financial transaction.

Any other party intercepting communications may, at most, obtain the prime number (P), the base number (B), the first communicated value (C₁) and the second communicated value (C₂). Even if the other party obtains all of the above as well as the first payment credential portion, it is not in possession of the communications device or payment processor private value (A₁ and A₂) and the payment credential encryption key (K). Therefore, such a party is prevented from obtaining the complete payment credentials required to transact against the account of the consumer (102).

It should be appreciated that the first communicated value may be formatted in any manner, but that it is preferably substantially similar to the format of the second payment credential portion such that it is capable of being accepted at an acceptance point of the merchant (120). For example, if the consumer (102) is required to enter the CVV on a webpage, the replacement CVV is preferably in such a format that it can be successfully entered instead of entering the actual CVV.

FIG. 4 shows three stages (400, 410, 420) of an exemplary implementation of a system and method for securely transmitting payment credentials. At a first stage (400), the consumer (402) uses an Internet-enabled computer (404) to access a website (406) associated with a merchant (408). The consumer (402) selects one or more items to purchase and the merchant (408) requests payment credentials from the consumer (402) via the website (406) so that the purchase can be made.

At a next stage (410), the consumer (402) obtains a first payment credential portion from a payment card (412) associated with a chosen financial account. For example, and as described above, the consumer (402) may obtain a PAN and card expiry date from the payment card (412). The consumer (402) may then proceed to input the first payment credential portion to the website.

In this example, the consumer (402) possesses a mobile communications device (414) which has a payment application as described above installed thereon. The payment application is used to generate a first communicated value which is then inputted to the website instead of inputting the second payment credential portion, which may, for example, be a CVV. The payment application may typically be configured so as to generate the first communicated value in a format substantially similar to the format of the second payment credential portion.

At a next stage (430), the mobile communications device (414) of the consumer (402) sets up a secure communications channel (416) which is at least symmetrically encrypted, but may in some embodiments also be asymmetrically encrypted, with the payment processor (418) such that the second payment credential portion can be securely transmitted to the payment processor (418), essentially bypassing the merchant (408) as described.

A system and method for securely transmitting payment credentials is therefore provided. A second payment credential portion is transmitted in an encrypted format and is required together with a first payment credential portion to form complete credentials required for conducting a transaction. A first communicated value replaces the second payment credential portion and enables the payment processor to generate an encryption key for ultimately decrypting the second payment credential portion. In this way, payment credentials of a consumer may be obscured to a merchant or any other miscreant attempting to intercept the credential.

The method and system provided may permit feature mobile phones, which may lack the capability to use sophisticated or advanced techniques for securely transmitting and receiving data, to take part in a transaction with a higher level of security.

It should be appreciated that although the key exchange protocol described with reference to FIG. 3 is Diffie-Hellman key exchange protocol, other key exchange protocols which are similar and/or substantially derived therefrom may also be used without departing from the scope of the invention. It should also be noted that one or more handshake steps between the communications device and the payment processor may take place to authenticate the communicating parties to each other before performing the key exchange.

The at least one shared value may be periodically updated. The payment processor may, for example, transmit a new primary number and base number to the communications device every day or every week. The communications device private value and/or the payment processor private value may also be periodically updated. In some embodiments, the communications device private value and/or the payment processor private value and/or the at least one shared value may be updated each time a respective first communicated value and/or second communicated value is generated.

In some embodiments, the first communicated value, and therefore also a particular payment credential encryption key, is valid only for a single use. In such as case, once a specific first communicated value has been used, the communications device may update its communications device private value. Likewise, once a specific second communicated value has been used, the payment processor may update its payment processor private value.

To enhance security, any one or more of the payment processor private value, the communications device private value and the at least one shared value may thus be dynamic.

Embodiments described herein may therefore enhance security levels associated with financial transactions and reduce the risk of fraudulent transactions being conducted with the payment credentials of a consumer as it may be more difficult to obtain the complete payment credentials required. This technique may be employed in, but is not limited to, card-not-present type transactions, wherein the consumer is typically required to provide a primary account number (PAN), a card expiry date and a Card Verification Value (CVV or “CVV2”) to the merchant.

FIG. 5 illustrates an example of a computing device (500) in which various aspects of the disclosure may be implemented. The computing device (500) may be suitable for storing and executing computer program code. The various participants and elements in the previously described system diagrams may use any suitable number of subsystems or components of the computing device (500) to facilitate the functions described herein.

The computing device (500) may include subsystems or components interconnected via a communication infrastructure (505) (for example, a communications bus, a cross-over bar device, or a network). The computing device (500) may include at least one central processor (510) and at least one memory component in the form of computer-readable media.

The memory components may include system memory (515), which may include read only memory (ROM) and random access memory (RAM). A basic input/output system (BIOS) may be stored in ROM. System software may be stored in the system memory (515) including operating system software.

The memory components may also include secondary memory (520). The secondary memory (520) may include a fixed disk (521), such as a hard disk drive, and, optionally, one or more removable-storage interfaces (522) for removable-storage components (523).

The removable-storage interfaces (522) may be in the form of removable-storage drives (for example, magnetic tape drives, optical disk drives, floppy disk drives, etc.) for corresponding removable storage-components (for example, a magnetic tape, an optical disk, a floppy disk, etc.), which may be written to and read by the removable-storage drive.

The removable-storage interfaces (522) may also be in the form of ports or sockets for interfacing with other forms of removable-storage components (523) such as a flash memory drive, external hard drive, or removable memory chip, etc.

The computing device (500) may include an external communications interface (530) for operation of the computing device (500) in a networked environment enabling transfer of data between multiple computing devices (500). Data transferred via the external communications interface (530) may be in the form of signals, which may be electronic, electromagnetic, optical, radio, or other types of signal.

The external communications interface (530) may enable communication of data between the computing device (500) and other computing devices including servers and external storage facilities. Web services may be accessible by the computing device (500) via the communications interface (530).

The external communications interface (530) may also enable other forms of communication to and from the computing device (500) including, voice communication, near field communication, Bluetooth, etc.

The computer-readable media in the form of the various memory components may provide storage of computer-executable instructions, data structures, program modules, and other data. A computer program product may be provided by a computer-readable medium having stored computer-readable program code executable by the central processor (510).

A computer program product may be provided by a non-transient computer-readable medium, or may be provided via a signal or other transient means via the communications interface (530).

Interconnection via the communication infrastructure (505) allows a central processor (510) to communicate with each subsystem or component and to control the execution of instructions from the memory components, as well as the exchange of information between subsystems or components.

Peripherals (such as printers, scanners, cameras, or the like) and input/output (I/O) devices (such as a mouse, touchpad, keyboard, microphone, joystick, or the like) may couple to the computing device (500) either directly or via an I/O controller (535). These components may be connected to the computing device (500) by any number of means known in the art, such as a serial port.

One or more monitors (545) may be coupled via a display or video adapter (540) to the computing device (500).

FIG. 6 shows a block diagram of a mobile device (600) that may be used in embodiments of the disclosure. The mobile device (600) may be a cell phone, a feature phone, a smart phone, a satellite phone, or a computing device having a phone capability.

The mobile device (600) may include a processor (605) (e.g., a microprocessor) for processing the functions of the mobile device (600) and a display (620) to allow a user to see the phone numbers and other information and messages. The mobile device (600) may further include an input element (625) to allow a user to input information into the device (e.g., input buttons, touch screen, etc.), a speaker (630) to allow the user to hear voice communication, music, etc., and a microphone (635) to allow the user to transmit his or her voice through the mobile device (600).

The processor (610) of the mobile device (600) may connect to a memory (615). The memory (615) may be in the form of a computer-readable medium that stores data and, optionally, computer-executable instructions.

The mobile device (600) may also include a communication element (640) for connection to communication channels (e.g., a cellular telephone network, data transmission network, Wi-Fi network, satellite-phone network, Internet network, Satellite Internet Network, etc.). The communication element (640) may include an associated wireless transfer element, such as an antenna.

The communication element (640) may include a subscriber identity module (SIM) in the form of an integrated circuit that stores an international mobile subscriber identity and the related key used to identify and authenticate a subscriber using the mobile device (600). One or more subscriber identity modules may be removable from the mobile device (600) or embedded in the mobile device (600).

The mobile device (600) may further include a contactless element (650), which is typically implemented in the form of a semiconductor chip (or other data storage element) with an associated wireless transfer element, such as an antenna. The contactless element (650) may be associated with (e.g., embedded within) the mobile device (600) and data or control instructions transmitted via a cellular network may be applied to the contactless element (650) by means of a contactless element interface (not shown). The contactless element interface may function to permit the exchange of data and/or control instructions between mobile device circuitry (and hence the cellular network) and the contactless element (650).

The contactless element (650) may be capable of transferring and receiving data using a near field communications (NFC) capability (or near field communications medium) typically in accordance with a standardized protocol or data transfer mechanism (e.g., ISO 14443/NFC). Near field communications capability is a short-range communications capability, such as radio-frequency identification (RFID), Bluetooth, infra-red, or other data transfer capability that can be used to exchange data between the mobile device (600) and an interrogation device. Thus, the mobile device (600) may be capable of communicating and transferring data and/or control instructions via both a cellular network and near field communications capability.

The data stored in the memory (615) may include: operation data relating to the operation of the mobile device (600), personal data (e.g., name, date of birth, identification number, etc.), financial data (e.g., bank account information, a bank identification number (BIN), credit or debit card number information, account balance information, expiration date, loyalty provider account numbers, etc.), transit information (e.g., as in a subway or train pass), access information (e.g., as in access badges), etc. A user may transmit this data from the mobile device (600) to selected receivers.

The mobile device (600) may be, amongst other things, a notification device that can receive alert messages and access reports, a portable merchant device that can be used to transmit control data identifying a discount to be applied, as well as a portable consumer device that can be used to make payments.

A computer program product may be provided for securely transmitting payment credentials to a payment processor, the computer program product comprising a computer-readable medium having stored computer-readable program code for performing one or more of the steps of: generating a first communicated value, the first communicated value having a similar format to a second payment credential portion; providing the first communicated value to the payment processor, the first communicated value acting as a replacement for the second payment credential portion in the transmittal of the payment credentials; receiving, from the payment processor, a second communicated value; generating a payment credential encryption key based at least on the second communicated value, wherein the payment processor generates the payment credential encryption key based at least on the first communicated value; encrypting the second payment credential portion using the payment credential encryption key, the second payment credential portion together with a first payment credential portion provided to the payment processor constituting complete payment credentials required to process a financial transaction; and transmitting the encrypted second payment credential portion to the payment processor such that the payment processor is capable of decrypting the encrypted second payment credential portion using the payment credential encryption key in order to be in possession of the complete payment credentials required to process the financial transaction.

Further, a computer program product may be provided for performing one or more of the following steps: receiving a first communicated value, the first communicated value having a similar format to a second payment credential portion; receiving a first payment credential portion; generating a second communicated value; transmitting the second communicated value to a communications device of a consumer; generating a payment credential encryption key based at least on the first communicated value, wherein the communications device generates the payment credential encryption key based at least on the second communicated value; receiving the second payment credential portion in an encrypted format, the second payment credential portion being encrypted using the payment credential encryption key, the second payment credential portion together with the first payment credential portion constituting complete payment credentials required to process a financial transaction; decrypting the encrypted second payment credential portion using the payment credential encryption key; and processing the financial transaction using the first payment credential portion together with the second payment credential portion.

The computer-readable medium may be a non-transitory computer-readable medium, the computer-readable program code being executable by a processing circuit.

The foregoing description of the embodiments of the invention has been presented for the purpose of illustration; it is not intended to be exhaustive or to limit the invention to the precise forms disclosed. Persons skilled in the relevant art can appreciate that many modifications and variations are possible in light of the above disclosure.

Some portions of this description describe the embodiments of the invention in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. The described operations may be embodied in software, firmware, hardware, or any combinations thereof.

The software components or functions described in this application may be implemented as software code to be executed by one or more processors using any suitable computer language such as, for example, Java, C++, or Perl using, for example, conventional or object-oriented techniques. The software code may be stored as a series of instructions, or commands on a non-transitory computer-readable medium, such as a random access memory (RAM), a read-only memory (ROM), a magnetic medium such as a hard-drive or a floppy disk, or an optical medium such as a CD-ROM. Any such computer-readable medium may also reside on or within a single computational apparatus, and may be present on or within different computational apparatuses within a system or network.

Any of the steps, operations, or processes described herein may be performed or implemented with one or more hardware or software modules, alone or in combination with other devices. In one embodiment, a software module is implemented with a computer program product comprising a non-transient computer-readable medium containing computer program code, which can be executed by a computer processor for performing any or all of the steps, operations, or processes described.

Finally, the language used in the specification has been principally selected for readability and instructional purposes, and it may not have been selected to delineate or circumscribe the inventive subject matter. It is therefore intended that the scope of the invention be limited not by this detailed description, but rather by any claims that issue on an application based hereon. Accordingly, the disclosure of the embodiments of the invention is intended to be illustrative, but not limiting, of the scope of the invention, which is set forth in the following claims.

Throughout the specification and claims unless the contents requires otherwise the word ‘comprise’ or variations such as ‘comprises’ or ‘comprising’ will be understood to imply the inclusion of a stated integer or group of integers but not the exclusion of any other integer or group of integers.

1. A method of securely transmitting payment credentials to a payment processor, the method carried out at a communications device of a consumer and comprising:
generating a first communicated value, the first communicated value having a similar format to a second payment credential portion;
providing the first communicated value to the payment processor, the first communicated value acting as a replacement for the second payment credential portion in the transmittal of the payment credentials;
receiving, from the payment processor, a second communicated value;
generating a payment credential encryption key based at least on the second communicated value, wherein the payment processor generates the payment credential encryption key based at least on the first communicated value;
encrypting the second payment credential portion using the payment credential encryption key, the second payment credential portion together with a first payment credential portion provided to the payment processor constituting complete payment credentials required to process a financial transaction; and
transmitting the encrypted second payment credential portion to the payment processor such that the payment processor is capable of decrypting the encrypted second payment credential portion using the payment credential encryption key in order to be in possession of the complete payment credentials required to process the financial transaction.

2. The method as claimed in claim 1, wherein the step of generating the first communicated value includes generating the first communicated value based on a communications device private value and at least one shared value being known to the payment processor and to the communications device, wherein the second communicated value is generated based on a payment processor private value and the at least one shared value, wherein the step of generating the payment credential encryption key includes generating the payment credential encryption key based on the second communicated value and the communications device private value, and wherein the payment processor generates the payment credential encryption key based on the first communicated value and the payment processor private value.

3. The method as claimed in claim 1, wherein the step of providing the first communicated value to the payment processor includes providing the first communicated value to a merchant for onward transmission to the payment processor.

4. The method as claimed in claim 3, wherein the first communicated value is provided to the merchant together with the first payment credential portion, and wherein the first communicated value is provided to the merchant instead of providing the merchant with the second payment credential portion such that the merchant is not in possession of the complete payment credentials required to process a financial transaction.

5. The method as claimed in claim 1, further including the step of encrypting the first payment credential portion using the payment credential encryption key and transmitting the encrypted first payment credential portion to the payment processor.

6. The method as claimed in claim 2, wherein the at least one shared value includes a prime number and a base number used with the communications device private value to generate the first communicated value, and used with the payment processor private value to generate the second communicated value.

7. The method as claimed in claim 1, wherein the similar format of the first communicated value enables the first communicated value to be accepted by a merchant as a second payment credential portion.

8. The method as claimed in claim 1, wherein the first communicated value is in a format substantially similar to a format of a card verification value (CVV) associated with a financial account of the consumer.

9. The method as claimed in claim 1, wherein the first payment credential portion includes a primary account number (PAN) and/or a card expiry date associated with a financial account of the consumer and is devoid of a CVV, and wherein the second payment credential portion is the CVV corresponding to the PAN and/or card expiry date.

10. The method as claimed in claim 2, wherein the communications device private value and/or the payment processor private value and/or the at least one shared value is periodically updated.

11. The method as claimed in claim 10, wherein the communications device private value and/or the payment processor private value and/or the at least one shared value is updated each time a respective first communicated value and/or second communicated value is generated.

12. The method as claimed in claim 1, wherein the first communicated value is valid for a single use only.

13. The method as claimed in claim 1, wherein the communications device is a feature phone.

14. A method of securely transmitting payment credentials to a payment processor, the method carried out at the payment processor and comprising:
receiving a first communicated value, the first communicated value having a similar format to a second payment credential portion;
receiving a first payment credential portion;
generating a second communicated value;
transmitting the second communicated value to a communications device of a consumer;
generating a payment credential encryption key based at least on the first communicated value, wherein the communications device generates the payment credential encryption key based at least on the second communicated value;
receiving the second payment credential portion in an encrypted format, the second payment credential portion being encrypted using the payment credential encryption key, the second payment credential portion together with the first payment credential portion constituting complete payment credentials required to process a financial transaction;
decrypting the encrypted second payment credential portion using the payment credential encryption key; and
processing the financial transaction using the first payment credential portion together with the second payment credential portion.

15. The method as claimed in claim 14, wherein the step of generating the second communicated value includes generating the second communicated value based on a payment processor private value and at least one shared value being known to the payment processor and to the communications device, wherein the first communicated value is generated based on a communications device private value and the at least one shared value, wherein the step of generating the payment credential encryption key includes generating the payment credential encryption key based on the first communicated value and the payment processor private value, and wherein the communications device generates the payment credential encryption key based on the second communicated value and the communications device private value.

16. The method as claimed in claim 14, wherein the step of receiving the first communicated value includes receiving the first communicated value from the consumer via a merchant.

17. A system for securely transmitting payment credentials to a payment processor, the system comprising a communications device of a consumer in communication with a payment processor, the communications device including:
a first generating component for generating a first communicated value, the first communicated value having a similar format to a second payment credential portion;
a provisioning component for providing the first communicated value to the payment processor, the first communicated value acting as a replacement for the second payment credential portion in the transmittal of the payment credentials;
a receiving component for receiving, from the payment processor, a second communicated value;
a second generating component for generating a payment credential encryption key based at least on the second communicated value, wherein the payment processor generates the payment credential encryption key based at least on the first communicated value;
a cryptographic component for encrypting the second payment credential portion using the payment credential encryption key, the second payment credential portion together with a first payment credential portion provided to the payment processor constituting complete payment credentials required to process a financial transaction; and
a transmitting component for transmitting the encrypted second payment credential portion to the payment processor such that the payment processor is capable of decrypting the encrypted second payment credential portion using the payment credential encryption key in order to be in possession of the complete payment credentials required to process the financial transaction.

18. A system for securely transmitting payment credentials to a payment processor, the system comprising a payment processor in communication with a communications device of a consumer, the payment processor including:
a value receiving component for receiving a first communicated value, the first communicated value having a similar format to a second payment credential portion;
a first payment credential component for receiving a first payment credential portion;
a first generating component for generating a second communicated value;
a transmitting component for transmitting the second communicated value to the communications device;
a second generating component for generating a payment credential encryption key based at least on the first communicated value, wherein the communications device generates the payment credential encryption key based at least on the second communicated value;
a second payment credential component for receiving the second payment credential portion in an encrypted format, the second payment credential portion being encrypted using the payment credential encryption key, the second payment credential portion together with the first payment credential portion constituting complete payment credentials required to process a financial transaction;
a cryptographic component for decrypting the encrypted second payment credential portion using the payment credential encryption key; and
a transaction processing component for processing the financial transaction using the first payment credential portion together with the second payment credential portion.

19. A computer program product for securely transmitting payment credentials to a payment processor, the computer program product comprising a computer-readable medium having stored computer-readable program code for performing the steps of:
generating a first communicated value, the first communicated value having a similar format to a second payment credential portion;
providing the first communicated value to the payment processor, the first communicated value acting as a replacement for the second payment credential portion in the transmittal of the payment credentials;
receiving, from the payment processor, a second communicated value;
generating a payment credential encryption key based at least on the second communicated value, wherein the payment processor generates the payment credential encryption key based at least on the first communicated value;
encrypting the second payment credential portion using the payment credential encryption key, the second payment credential portion together with a first payment credential portion provided to the payment processor constituting complete payment credentials required to process a financial transaction; and
transmitting the encrypted second payment credential portion to the payment processor such that the payment processor is capable of decrypting the encrypted second payment credential portion using the payment credential encryption key in order to be in possession of the complete payment credentials required to process the financial transaction.

20. A computer program product for securely transmitting payment credentials to a payment processor, the computer program product comprising a computer-readable medium having stored computer-readable program code for performing the steps of:
receiving a first communicated value, the first communicated value having a similar format to a second payment credential portion;
receiving a first payment credential portion;
generating a second communicated value;
transmitting the second communicated value to a communications device of a consumer;
generating a payment credential encryption key based at least on the first communicated value, wherein the communications device generates the payment credential encryption key based at least on the second communicated value;
receiving the second payment credential portion in an encrypted format, the second payment credential portion being encrypted using the payment credential encryption key, the second payment credential portion together with the first payment credential portion constituting complete payment credentials required to process a financial transaction;
decrypting the encrypted second payment credential portion using the payment credential encryption key; and
processing the financial transaction using the first payment credential portion together with the second payment credential portion.
